(19) United States
(12) Patent Application Publication
(10) Pub. No.: US 2007/0192388 A1
(43) Pub. Date: Aug. 16, 2007

(54) Method of and apparatus for managing memory

(75) Inventor: Jagun Kwon, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/729,868

(22) Filed: Mar. 30, 2007

(30) Foreign Application Priority Data
Jan. 27, 2006 (KR) 10-2006-0105271

(51) Int. Cl. G06F 17/30

(52) U.S. Cl. 707/206

(57) ABSTRACT

A method of and apparatus for managing memory are provided. The method includes scheduling a garbage collection to be carried out on a predetermined heap in a memory after running of real-time threads is completed and carrying out the garbage collection according to the scheduling. Since the memory areas allocated to run the real-time thread are managed in the heap, dangling references can be prevented from being created, thereby securing safety of the running of threads.

### CROSS-REFERENCE TO RELATED PATENT APPLICATION

This application claims priority from Korean Patent Application No. 10-2006-0105271, filed on Oct. 27, 2006, in the Korean Intellectual Property Office, the disclosure of which is incorporated herein in its entirety by reference.

### BACKGROUND OF THE INVENTION

1. Field of the Invention

Apparatuses and methods consistent with the present invention relates to managing memory, and more particularly, to managing memory by efficiently performing a garbage collection.

2. Description of the Related Art

In a system managing memory dynamically, memory should be allocated and collected every time a predetermined program is run. Memory is allocated for objects used in the program to be stored and accessed, and the objects that have completed their use are removed to secure memory. Therefore, in a conventional C language, a programmer allocates memory and collects memory using an instruction such as ‘malloc’ or ‘free’.

However, unlike the conventional C language, a programmer is not required to allocate and collect memory in Java. Memory management is performed by a garbage collector included in a Java virtual machine. Once a predetermined program is run, the Java virtual machine firstly allocates a memory area required in running the predetermined program. This is referred to as a heap. The objects required in running the program are stored in the heap to be accessed. The garbage collector deletes and compacts objects that are not used among the objects stored in the heap so that memory is effectively managed.

The garbage collector determines whether the objects are referenced to determine the objects used and not used, and only objects not used are removed from memory. Therefore, when only a garbage collector is used to manage memory, the objects used are not removed so that a dangling reference does not occur, wherein the dangling reference references objects not existing in the memory.

However, similar to the real-time specification for Java, a memory area can be separately specified by a programmer to be used in some programming languages and thus a problem can occur.

FIG. 1 is a block diagram for explaining a related art method of managing memory according to the real-time specification for Java. Referring to FIG. 1, memory is managed using two methods in the real-time specification for Java.

One program may consist of a plurality of threads. For example, in the case of a chatting program, a thread sending text inputted by a user to the other user and a thread receiving the inputted text by the other user separately exist.

A plurality of threads existing in one program can be divided into real-time threads 15 and normal threads 16 according to their characteristics. A real-time thread 15 must be run in a fixed time prior to the normal thread 16. Therefore, a preemptive real-time scheduler 11 adjusts the priority of the threads so that the real-time thread 15 is scheduled to be run prior to the normal thread 16.

When running the normal thread 16, the objects required in the running of the threads are stored in a heap 13 and the objects are accessed to run the threads. Here, a garbage collector 12 manages memory and determines whether the objects stored in the heap 13 are used. Then, after the objects not used are determined, the determined not used objects are removed from the memory and remaining objects are compacted.

When running the real-time thread 15, a plurality of memory areas 14 are set, separately from the heap 13 and the objects required in running the threads are stored in the memory areas 14 to be accessed. Each of the memory areas 14 can be referenced by one or more real-time threads 15. When the threads referenced are all gone, the memory areas 14 are removed with the objects included.

As illustrated in FIG. 1, when a memory management is dualized into the heap 13 and the memory areas 14, the following problems can occur.

A garbage collection which is performed on the heap 13 while regarding the heap 13 as an object takes a long time. Various algorithms which carry out a garbage collection have been developed. However, they take a long time, for example, up to a few seconds at most.

Therefore, in spite of a schedule to run the real-time thread 15, if a garbage collection is firstly carried out, running the real-time thread 15 is delayed and the time delay cannot be estimated. The preemptive real-time scheduler 11 only adjusts the priority between the real-time thread 15 and the normal thread 16 and thus cannot prevent such problem.

A problem can also occur when it is required to run the real-time thread 15 while a garbage collection is already carrying out. If running the real-time thread 15 should wait until a garbage collection is completed, the real-time thread 15 cannot be run normally, wherein running the real-time thread 15 in a fixed time should be the most important task.

Furthermore, the memory areas 14 each include a different life time. Therefore, the objects included in the memory area having a long life time reference the objects included in the memory area having a relatively short life time. When a memory area having a short life time is removed, a dangling reference can occur.

This will be described more fully with reference to FIG. 2.

FIG. 2 illustrates a related art method of referencing the memory areas 14 by the real-time thread 15.

Referring to FIG. 2, thread A references a plurality of the memory areas sequentially from memory area 1 to memory area 3. In the real-time specification for Java, the memory area last referenced is deleted first from a memory area stack (last-in first-out). In FIG. 2, the memory area 3 is deleted before the memory area 2 or the memory area 1 is deleted. Therefore, if each of the memory areas is not referenced by threads other than thread A, the life time of the memory area 3 is shorter than that of the memory area 1.

If the memory area 3 is deleted while the objects included in the memory area 1 still reference the objects included in the memory area 3, the objects included in the memory area 1 reference the objects in a nonexistent memory.

In addition, when the objects included in the heap 13 reference the objects included in the memory area, the memory area may be deleted and thus dangling references can occur. The Java virtual machine only determines whether there is a thread referencing the memory area. When the thread referencing the memory area does not exist, the memory area is deleted. Therefore, when the objects included in the heap 13 reference the objects included in the memory area, the memory area can be deleted, even if the objects are still used. In this case, the objects included in the heap 13 reference nonexistent objects in the memory and thus a dangling reference occurs.

Therefore, a method of managing memory is required to secure running of the real-time thread 15 in a real-time and to prevent illegal referencing which generates a dangling reference.

### SUMMARY OF THE INVENTION

The present invention provides a method of and apparatus for managing memory by efficiently carrying out a garbage collection.

The present invention also provides a computer readable medium having embodied thereon a computer program for the above method.

According to an aspect of the present invention, there is provided a method of managing memory including: scheduling a garbage collection to be carried out on a heap in the memory after running of real-time threads is completed; and carrying out the garbage collection on the predetermined heap according to the above scheduling.

The carrying out of the garbage collection may include carrying out the garbage collection according to a real-time specification for Java.

The heap may include a memory area in which objects used to run a real-time thread are included.

The carrying out of the garbage collection may include carrying out the garbage collection on the memory area included in the heap.

According to another aspect of the present invention, there is provided an apparatus for managing memory including: a scheduler scheduling a garbage collection to be carried out on a predetermined heap in the memory after running of real-time threads is completed; and a garbage collector carrying out the garbage collection on the predetermined heap according to the above scheduling.

The garbage collector may carry out garbage collection according to a real-time specification for Java.

The predetermined heap may include a memory area in which objects used to run real-time thread are included.

The garbage collector may carry out the garbage collection on the memory area included in the heap.

According to another aspect of the present invention, there is provided a computer readable medium having embodied thereon a computer program for the method described above.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram for explaining a related art apparatus for managing memory;

FIG. 2 illustrates a related art method of referencing memory areas by real-time thread;

FIG. 3 is a block diagram for explaining an apparatus for managing memory according to an exemplary embodiment of the present invention;

FIG. 4 is a flow chart illustrating a method of managing memory according to an exemplary embodiment of the present invention;

FIG. 5 is a flow chart illustrating a method of carrying out a garbage collection according to an exemplary embodiment of the present invention;

FIGS. 6A and 6B are block diagrams for explaining a method of compacting memory areas according to an exemplary embodiment of the present invention;

FIG. 7 is a flow chart for explaining a method of carrying out a garbage collection according to another exemplary embodiment of the present invention; and

FIG. 8 illustrates an example of an exception handling according to an exemplary embodiment of the present invention.

### DETAILED DESCRIPTION OF EXEMPLARY EMBODIMENTS OF THE INVENTION

Hereinafter, the present invention will be described more fully with reference to the accompanying drawings, in which exemplary embodiments of the invention are shown.

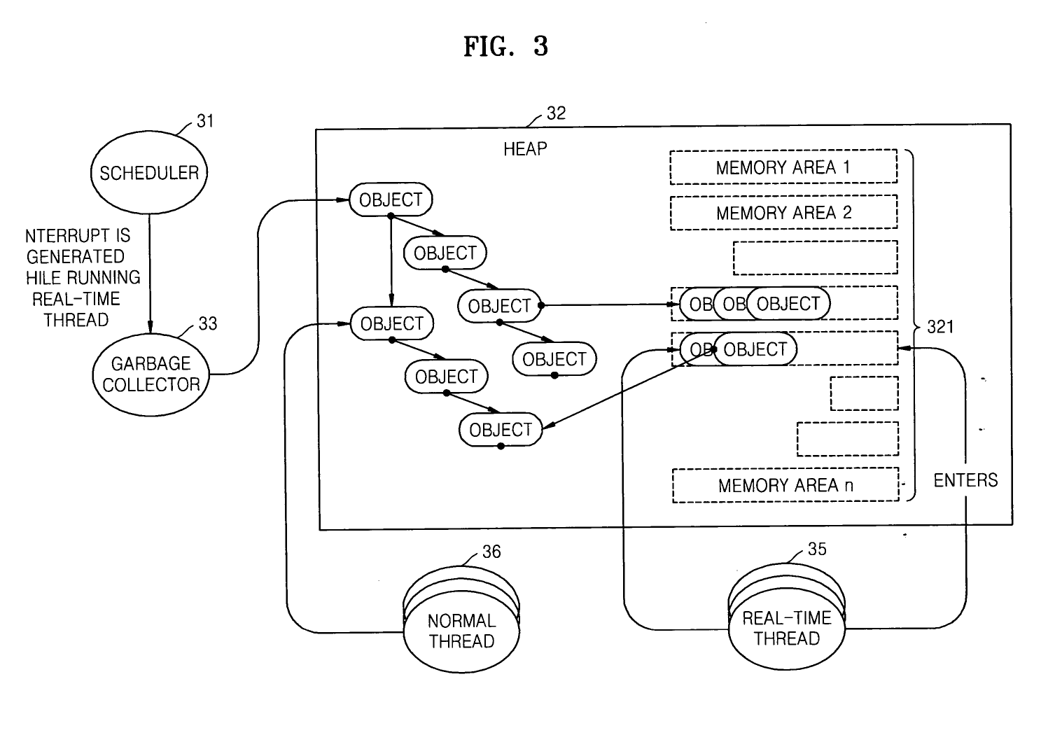

FIG. 3 is a block diagram for explaining an apparatus for managing memory according to an exemplary embodiment of the present invention.

The apparatus for managing memory according to an exemplary embodiment of the present invention includes a scheduler 31, a heap 32, and a garbage collector 33.

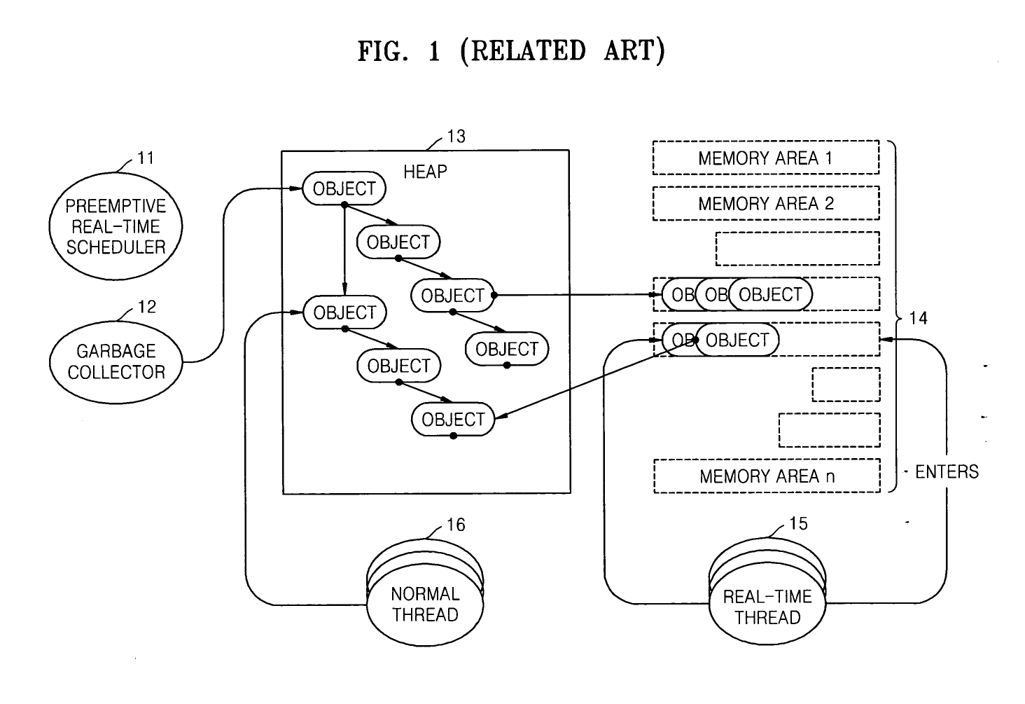

Referring to FIG. 3, similar to the related art preemptive real-time scheduler 11 of FIG. 1, the scheduler 31 according to an exemplary embodiment of the present invention adjusts the priority between threads so that real-time threads 35 are scheduled to be run prior to normal threads 36.

In addition, the scheduler 31 generates an interrupt with respect to the garbage collector 33 in order for a garbage collection to be carried out after running of all real-time threads 35 is completed. If the garbage collection is not yet carried out, the garbage collection is scheduled to be carried out after running of all real-time threads 35 is completed, wherein the real-time threads 35 are currently running or are due to be run. If an attempt to run a real-time thread 35 occurs while the garbage collection is already being carried out, an interrupt is generated with respect to the garbage collector 33 so as to carry out the garbage collection after the real-time thread 35 is first completed.

Since the scheduler 31 adjusts the priority between the threads and schedules the real-time thread to not be prevented from running by the garbage collection, running of the real-time thread 35 can be secured without delay.

Similar to the related art heap 13 of FIG. 1, the heap 32 according to an exemplary embodiment of the present invention stores objects required in running the normal thread 36. A predetermined program is run and, at the same time, the heap 13 is allocated by a Java virtual machine.

In addition, the heap 32 includes a plurality of memory areas 321 set by a user for running the real-time thread 35. According to a conventional real-time specification for Java, when running the real-time thread 15, memory areas 14 are set, separately from the heap 13 and the objects required in running the threads are stored in the memory areas 14 to be accessed. However, according to an exemplary embodiment of the present invention, while the real-time thread 35 is running, the memory areas 321 are set in the heap 32, instead of the outside of the heap 32.

The memory areas 321 are set in the heap 32 and the set memory areas 321 are managed by the garbage collector 33 which will be described later. In order to prevent a dangling reference, both objects required in running the normal thread 36 and objects required in running the real-time thread 35 are stored in the heap 32 and are managed by the garbage collector 33.

Similar to the related art garbage collector 12 of FIG. 1, the garbage collector 33 according to an exemplary embodiment of the present invention carries out a garbage collection with respect to the objects existing in the heap 32. The garbage collector 33 determines whether the objects stored in the heap 32 are used. The objects not used are removed from memory and remaining objects are compacted.

In addition, the garbage collector 33 carries out the garbage collection with respect to the memory areas 321 included in the heap 32. A method of carrying out the garbage collection by the garbage collector 33 will be described in detail later.

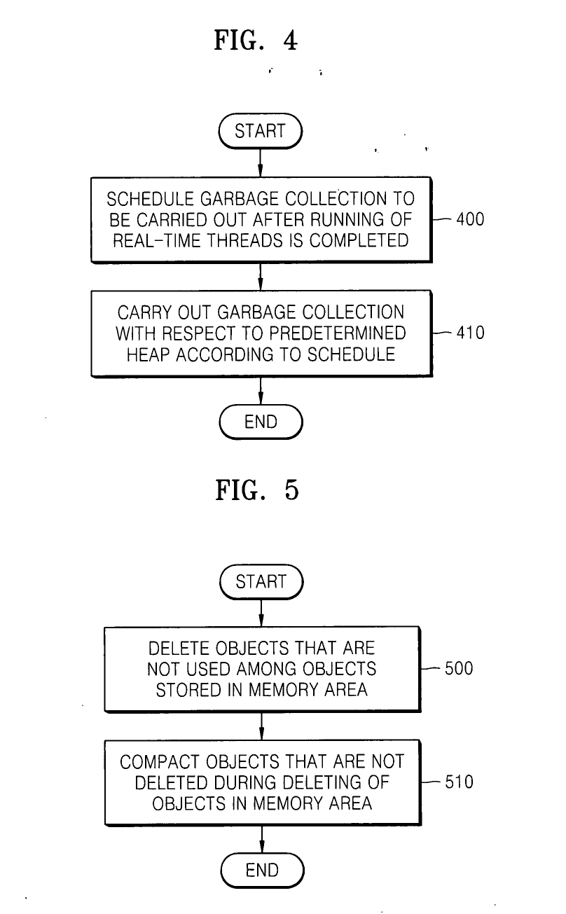

FIG. 4 is a flow chart illustrating a method of managing memory according to an exemplary embodiment of the present invention.

Referring to FIG. 4, the apparatus for managing memory according to an exemplary embodiment of the present invention schedules for the garbage collection to be carried out after running the real-time thread 35 is completed in operation 400.

If the garbage collection has not yet been carried out, the garbage collection is scheduled to be carried out after running of all real-time threads 35 is completed, wherein the real-time threads 35 are currently running or are due to be run. If the real-time thread attempts to run while the garbage collection is already being carried out, an interrupt is generated so as to carry out the garbage collection after the real-time thread is firstly run.

In operation 410, the apparatus for managing memory according to an exemplary embodiment of the present invention carries out the garbage collection according to the schedule set previously in operation 400. This will be described more fully with reference to FIGS. 5 through 7.

FIG. 5 is a flow chart illustrating a method of carrying out the garbage collection according to an exemplary embodiment of the present invention.

Referring to FIG. 5, the apparatus for managing memory according to an exemplary embodiment of the present invention deletes the objects that are not used among the objects stored in the predetermined memory area in operation 500. In the real-time specification for Java, the garbage collection is only carried out with respect to the objects required in running the normal thread 16, wherein the normal thread 16 is stored in the heap 13.

However, according to an exemplary embodiment of the present invention, the memory areas 321 allocated for running the real-time thread 35 are also included in the heap 32 and thus the garbage collection is carried out with respect to the memory areas 321 included in the heap 32.

In order to carry out the garbage collection, the apparatus for managing memory according to an exemplary embodiment of the present invention firstly deletes the objects that are not used among the objects stored in the memory area. The size of the memory areas 321 allocated for running the real-time thread 35 is set by a programmer at the time the program is designed by the programmer. If the programmer does not sufficiently set the memory size, the real-time thread 35 may not be able to store objects in the memory areas 321 when the memory is completely full. As time for creating new memory areas 321 by the thread and allocating the objects is delayed, a spare space to store objects in the memory areas 321 is secured by deleting objects that are not used.

In operation 510, the apparatus for managing memory according to an exemplary embodiment of the present invention compacts the objects that are not deleted in the memory areas 321. An allocation pointer which points out spare space in the memory areas 321 is set based on the last object stored in the memory area and thus the objects are continuously stored from the initial portion of the memory area so that an empty space is not made.

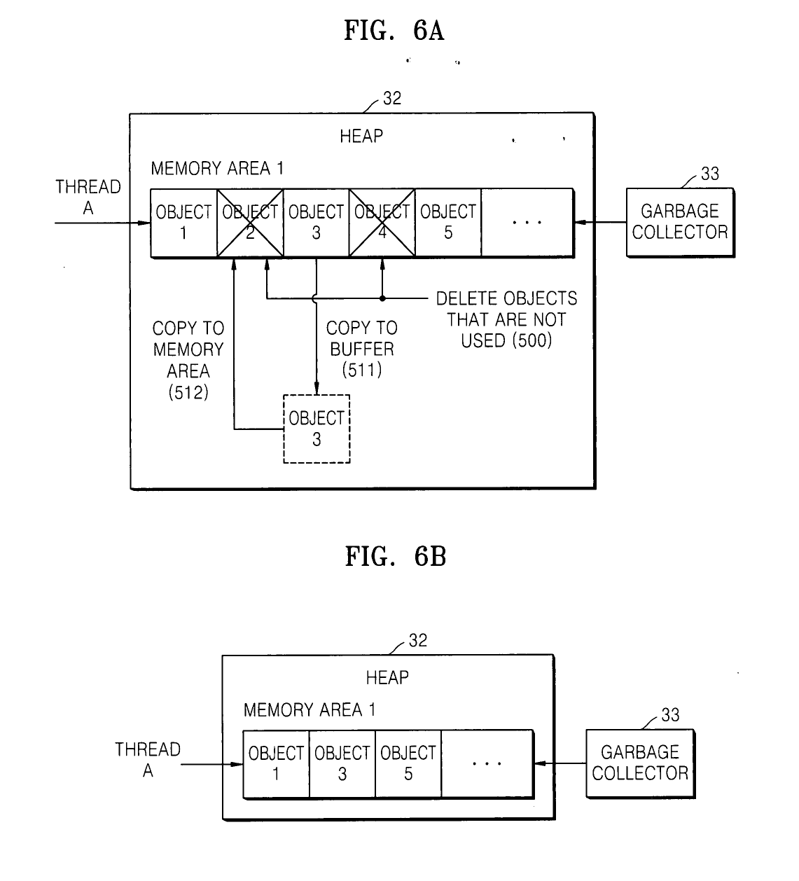

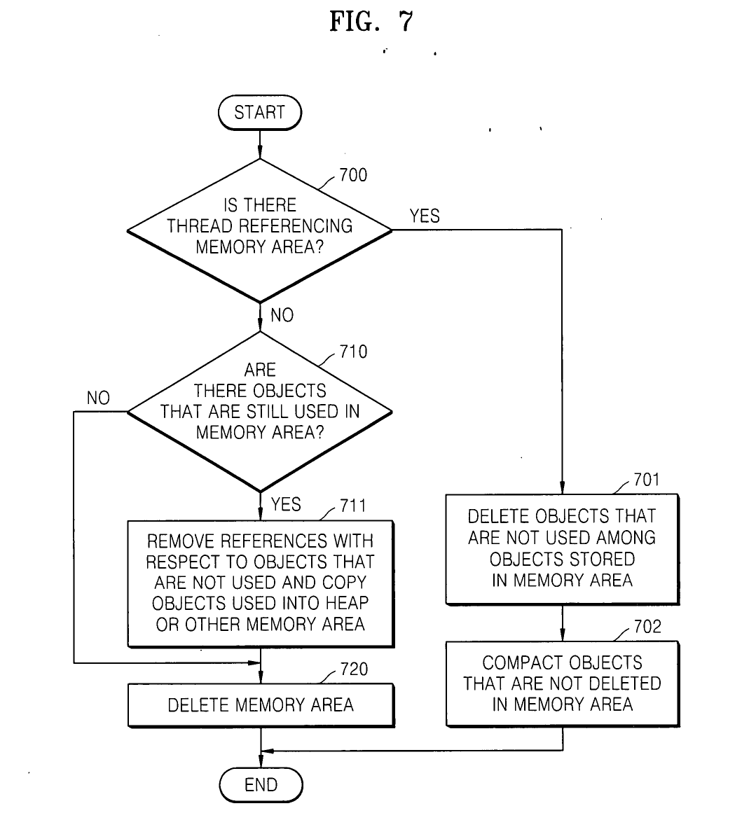

FIGS. 6A and 6B are block diagrams for explaining a method of compacting the memory areas 321 according to an exemplary embodiment of an embodiment of the present invention.

Referring to FIG. 6A, thread A references the memory area 1 and the memory area 1 includes the objects 1, 2, 3, 4, 5, etc. Here, the objects 2 and 4 are assumed to be objects that are not used any more.

In operation 500, the apparatus for managing memory according to the present invention deletes the objects that are not used in the memory area 1. When the objects included in the memory area 1 are not referenced by other objects, these objects are determined as the objects that are not used anymore and are deleted from the memory area. In FIG. 6A, the objects 2 and 4 are not used, and therefore these objects are deleted from the memory area 1.

Operation 510 which is for compacting the remaining objects of the memory area includes operations 511 and 512.

In operation 511, the apparatus for managing memory copies the remaining objects into a temporary buffer in the heap 32.

In operation 512, the apparatus for managing memory continuously stores the objects copied in the temporary buffer to the memory area starting from the initial portion of the memory area so that an empty space is not made. FIG. 6B illustrates the memory area 1 when the compacting is completed.

FIG. 7 is a flow chart for explaining a method of carrying out the garbage collection according to another exemplary embodiment of the present invention.

In operation 700, the apparatus for managing memory according to an exemplary embodiment of the present invention determines whether there is thread referencing the memory area.

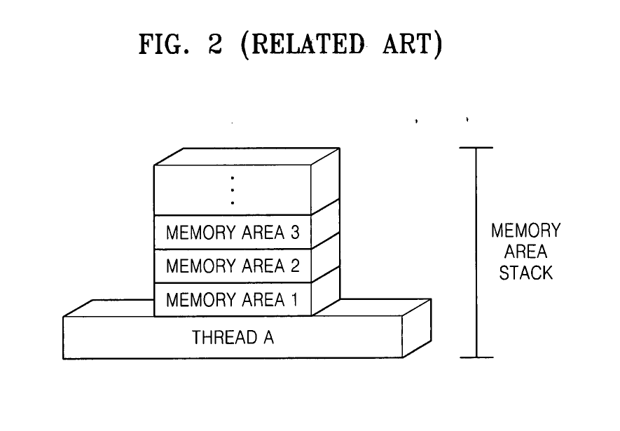

The memory areas 321 are allocated for running the real-time thread 35 and are referenced sequentially by the memory areas 321 having a stack structure as illustrated in FIG. 2. One memory area can be referenced by a plurality of threads. In the real-time specification for Java, a method of identifying the number of threads which reference the predetermined memory area is provided by the Java virtual machine.

A thread reference counter in the real-time specification for Java identifies the number of threads referencing a predetermined memory area, and when a change in the number is found, the thread reference counter reflects this.

If the thread referencing the predetermined memory area still remains according to a result determined in operation 700, the memory area cannot be deleted and thus the garbage collection is carried out with respect to the memory areas 321 through operations 701 and 702. Operations 701 and 702 are same as operations 500 and 510, respectively.

When each time the number of threads referencing the memory areas 321 decreases one by one, the garbage collection is carried out to immediately remove the objects that are not used.

If it is determined that the thread referencing the predetermined memory area does not exist in operation 700, operations 710 through 720 are performed to remove the memory areas 321.

In operation 710, the apparatus for managing memory according to an exemplary embodiment of the present invention determines whether there are objects still used in the memory areas 321. Even if the threads referencing the memory areas 321 are all gone, each object included in the memory areas 321 to be deleted may be referenced by other objects that are in the outside of the memory areas 321. The other objects that are outside of the memory areas 321 may be stored in the heap 32 for the normal thread 36 or may be stored in other memory areas 321.

The thread reference counter of the real-time specification for Java only counts the number of threads referencing the memory areas 14 so that the number of times the objects included in the memory areas 14 are referenced by the other objects outside the memory areas 14 cannot be counted by the thread reference counter. Accordingly, even if the thread reference counter points out that the thread referencing the memory area does not exist, the objects included in the memory areas 14 may be referenced by other objects that are outside of the memory areas 14. Therefore, if the memory areas 14 are deleted, the objects referenced are lost and thus a dangling reference occurs. In order to prevent this, operation 711 is performed.

In operation 711, the apparatus for managing memory according to an exemplary embodiment of the present invention removes all references with respect to the objects that are still used or copies the objects used into the heap 32 or other memory areas 321. Dangling references may cause serious error and thus the objects that are still used and relevant references are all removed or copied into another portion of the memory. Here, the other portion of the memory may be another memory area or another portion of the heap 32 allocated for the normal thread.

A programmer should be informed if a dangling reference occurs. Then, the references are removed or the objects are copied according to the decision of the programmer. In Java, when errors occur during the running of a program, an exception is generated in order to inform the programmer. Also, in the case of dangling reference generation with respect to objects included in the memory areas 321, the programmer is informed using the exception.

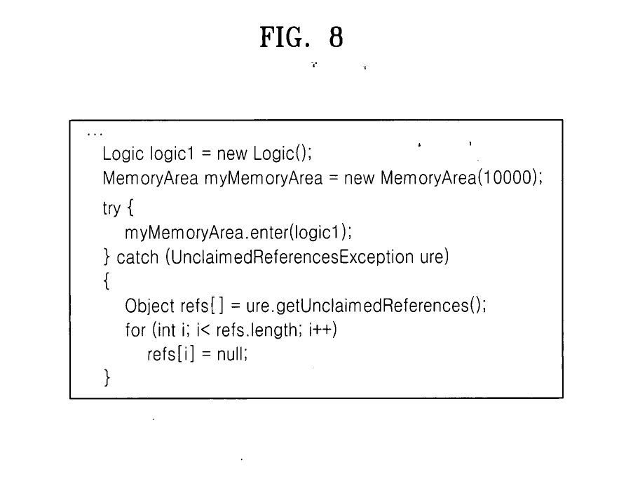

FIG. 8 illustrates an example of an exception handling according to an exemplary embodiment of the present invention.

Referring to FIG. 8, as illustrated above, if the objects that are used still remain at the time when the memory areas 321 are deleted, the Java virtual machine generates an exception and removes the references relevant to the objects using, for example, the instructions illustrated in FIG. 8.

In FIG. 8, when the running of thread titled ‘logic 1’ is completed and the memory area titled ‘mymemoryarea’ is deleted, for the objects that are used and remain, an exception titled ‘UnclaimedReferenceException’ is generated.

When an exception is generated, information of the objects that are still used and all relevant references is obtained by ‘getUnclaimedReferences’ and the references are all removed.

In FIG. 8, by removing all references relevant to the objects that are used while deleting the memory area, a dangling reference is prevented. Alternatively, a dangling reference is prevented by copying the objects into the other portion of memory to be continuously used.

When handling of the objects that are still used is completed in operation 711, the apparatus for managing memory according to an exemplary embodiment of the present invention deletes the memory areas that are not referenced by a thread in operation 720.

According to an exemplary embodiment of the present invention, after running of the real-time thread 35 is completed, the garbage collection is carried out so that running of the real-time thread 35 is not delayed by the garbage collection and thus is secured.

In addition, the memory areas 321 allocated to run the real-time thread 35 are managed in the heap 32 and thus a dangling reference can be prevented, thereby securing safety of running of the thread.

While the present invention has been particularly shown and described with reference to exemplary embodiments thereof, it will be understood by those of ordinary skill in the art that various changes in form and details may be made therein without departing from the spirit and scope of the present invention as defined by the following claims. In addition, the system of the invention can be embodied as computer readable codes on a computer readable recording medium. The computer readable recording medium may be any data storage device that can store data which can be thereafter read by a computer system. Examples of the computer readable recording medium include read-only memory (ROM), random-access memory (RAM), compact disc (CD)-ROMs, magnetic tapes, floppy disks, and optical data storage devices. The computer readable recording medium can also be distributed over network coupled computer systems so that the computer readable code is stored and executed in a distributed fashion.

What is claimed is:

1. A method of managing a memory, the method comprising:
scheduling a garbage collection to be carried out on a heap in the memory after running of real-time threads is completed; and
carrying out the garbage collection on the heap according to the scheduling.

2. The method of claim 1, wherein the carrying out of the garbage collection comprises carrying out the garbage collection according to a real-time specification for Java.

3. The method of claim 1, wherein the heap comprises a memory area in which objects used to run a real-time thread are stored.

4. The method of claim 3, wherein the carrying out of the garbage collection comprises carrying out the garbage collection on the memory area.

5. The method of claim 4, wherein the carrying out of the garbage collection comprises:
deleting objects that are not used among the objects stored in the memory area; and
compacting objects that are not deleted by the deleting of objects in the memory area.

6. The method of claim 4, wherein the carrying out of the garbage collection comprises:
determining whether threads referencing the memory area exist; and
selectively deleting the memory area according to a result of the determining.

7. The method of claim 6, wherein deleting the memory area comprises:
determining whether there are objects used in the memory area if it is determined that threads referencing the memory area do not exist;
removing references with respect to the objects used or copying the objects used into the heap or another memory area; and
deleting the memory area.

8. An apparatus for managing a memory, the apparatus comprising:
a scheduler which schedules a garbage collection to be carried out on a heap in the memory after running of real-time threads is completed; and
a garbage collector which carries out the garbage collection on the heap according to the scheduling.

9. The apparatus of claim 8, wherein the garbage collector carries out garbage collection according to a real-time specification for Java.

10. The apparatus of claim 8, wherein the heap comprises a memory area in which objects used to a run real-time thread are stored.

11. The apparatus of claim 10, wherein the garbage collector carries out the garbage collection on the memory area.

12. The apparatus of claim 11, wherein the garbage collector deletes objects that are not used among the objects stored in the memory area and compacts objects that are not deleted after the objects that are not used are deleted.

13. The apparatus of claim 11, wherein the garbage collector determines whether threads referencing the memory area exist and selectively deletes the memory area according to a result of the determination.

14. A computer readable medium having embodied thereon a computer program for performing a method of managing a memory, the method comprising:
scheduling a garbage collection to be carried out on a heap in the memory after running of real-time threads is completed; and
carrying out the garbage collection on the heap according to the scheduling.

15. The computer readable medium of claim 14, wherein the carrying out of the garbage collection comprises carrying out the garbage collection according to a real-time specification for Java.

16. The computer readable medium of claim 14, wherein the heap comprises a memory area in which objects used to run a real-time thread are stored.

17. The computer readable medium of claim 16, wherein the carrying out of the garbage collection comprises carrying out the garbage collection on the memory area.

18. The computer readable medium of claim 17, wherein the carrying out of the garbage collection comprises:
deleting objects that are not used among the objects stored in the memory area; and
compacting objects that are not deleted by the deleting of objects in the memory area.

19. The computer readable medium of claim 17, wherein the carrying out of the garbage collection comprises:
determining whether threads referencing the memory area exist; and
selectively deleting the memory area according to a result of the determining.

20. The computer readable medium of claim 19, wherein deleting the memory area comprises:
determining whether there are objects used in the memory area if it is determined that threads referencing the memory area do not exist;
removing references with respect to the objects used or copying the objects used into the heap or another memory area; and
deleting the memory area.
